(19) United States
(12) Patent Application Publication
(10) Pub. No.: US 2023/0047959 A1
(43) Pub. Date: Feb. 16, 2023

(54) CLEANING COMPOSITIONS EMPLOYING INFUSED GEL

(71) Applicant: MicroCare, LLC, New Britian, CT (US)

(72) Inventors: Edward A. Cassinis, Highlands Ranch, CO (US); Ross Gustafson, Commerce City, CO (US)

(21) Appl. No.: 17/884,562

(22) Filed: Aug. 10, 2022

Related U.S. Application Data
(60) Provisional application No. 63/231,256, filed on Aug. 10, 2021.

(51) Int. Cl. C11D 3/38; A01N 63/22; C11D 3/382; A01N 25/02; C11D 3/48

(52) U.S. Cl. CPC C11D 3/381; A01N 63/22; C11D 3/382; A01N 25/02; C11D 3/48

(57) ABSTRACT

A cleaning composition and uses thereof comprising an aqueous-based gel carrier with a pH range of 5.0-10.0 to remove organic matter from medical devices is described. The gel carrier is infused with viable Bacillus subtilis to enzymatically remove organic matter in a short period of time.

### RELATED APPLICATIONS

This application claims priority to U.S. Provisional Patent Application Ser. No. 63/231,256, filed Aug. 10, 2021, entitled “Cleaning Compositions Employing Infused Gel”, which is hereby incorporated by reference.

### FIELD OF THE INVENTION

A gel infused with bacterium such as Bacillus subtilis is an improved enzymatic cleaner of medical devices or instruments following use of the device. Said application of gel occurs following use of the device or instrument and may continue while the devices and/or instruments are in transport from a patient treatment site to a cleaning and/or sterilization site. In one embodiment the bacterium produces specific enzymes in situ such that stains and residues are removed by enzymatic digestion. In one embodiment, the cleaning composition is an environmentally friendly, aqueous-based gel composition containing specific surfactants and viable bacteria to remove and degrade organic compounds from medical devices. In one embodiment, the gel is both non-irritating and non-corrosive, and is stabilized by plant-based or other surfactants.

A method for cleaning medical devices that are contaminated with organic or lipophilic wastes via biodegradation of the wastes by applying the said gel is disclosed.

A method for precleaning medical devices during transport from a patient treatment site to a cleaning and/or sterilization site using a gel infused with Bacillus subtilis.

### BACKGROUND OF THE INVENTION

The following description provides a summary of information relevant to the present disclosure and is not an admission that any of the information provided or publications referenced herein is prior art to the present disclosure.

The use of enzymes in the cleaning industry has been known for many years. Especially useful enzymes used in the cleaning industry are proteases, lipases, amylases and cellulases. These enzymes can hydrolyze long protein and hydrocarbon chains associated with contaminants, thereby removing them from surfaces, without friction, as otherwise provided by brushes or sponges or with agitation provided by pressurized water.

The use of enzymes in cleaning formulations is complicated by the enzymes' limited stability in solution. Two processes that limit the shelf-life of an enzyme are denaturation and in the case of a protease, autolysis. Attempts to stabilize proteases in solution have been made by selecting optimal formulation components and pH conditions. Autolysis of proteases may also be minimized by the inclusion of a protease inhibitors. Typically, the inhibitor is released from the enzyme upon dilution and proteolytic activity is restored.

A need exists for cleaning compositions wherein medical devices and/or instruments can be cleaned, including precleaning following use, but prior to the device/instrument arriving at a sterilization site.

### SUMMARY OF THE INVENTION

In one embodiment a method for production of a cleansing gel containing viable Bacillus subtilis spores is described. The organism is stabilized and incorporated into a non-corrosive gel allowing the bacterium to produce the enzymes necessary for biodegradation of specific organic residues. The resulting gel has superior use as a transport/pre-cleaning product when compared to foam-type enzymatic cleaners or gel-based non-enzymatic cleaners. The resulting gel has the cleaning power of a multi-enzyme product.

In one embodiment, a method of manufacture and use of a non-corrosive gel infused with viable Bacillus subtilis spores is described. The viable bacteria produce enzymes in an amount effective to degrade and to promote degradation of organic materials. In one embodiment, the gel also provides a surfactant. In one embodiment, the surfactants to be used are products known in the art, used to reduce the surface tensions between the cleaning product and the surface to be cleaned, enabling the bacteria to interact with the contaminants before rinsing the gel off the surface of the device. In one embodiment, the gel is composed of plant-based surfactants.

In one embodiment, cleaning medical devices made of metal, glass, ceramic or plastic parts, or any other surface is described.

In one embodiment, a method wherein at least one strain of Bacillus subtilis is infused into a gel is described. In one embodiment, the infusion is enhanced by a surfactant. In one embodiment the surfactant is non-ionic. In one embodiment, the surfactant is ionic. In one embodiment, the surfactant is plant based.

In one embodiment, a method where at least one strain of Bacillus subtilis is used to enzymatically remove organic material from a medical device is described. In one embodiment, the medical device comprises a metal part. In one embodiment, the medical device comprises a plastic part. In one embodiment, the medical device comprises an electronic part. In one embodiment, the medical device comprises a ceramic part. In one embodiment, the medical device comprises parts made of metal, plastic, electronic, ceramic and/or combinations thereof.

The In one embodiment, a cleaning composition comprising a surfactant and viable Bacillus subtilis is described. In one embodiment, the composition has a pH range of 5-10. In one embodiment, the surfactant is non-ionic. In one embodiment, the surfactant is ionic. In one embodiment, the surfactant is plant based.

In one embodiment, a method for cleaning surgical equipment is described, comprising contacting equipment with the composition comprising a surfactant and viable Bacillus subtilis, having the equipment remain in contact with said composition for at least 10 minutes, and rinsing the composition from said equipment with water. In one embodiment, contact of the surfactant and viable Bacillus subtilis with the equipment is for at least 30 minutes. In one embodiment, the rinsing of the composition results in the removal of 90% of all organic material. In one embodiment, the rinsing of the composition results in the removal of 90% of organic material. In one embodiment, the removal of organic material is 95%. In one embodiment, the removal of organic material is 99%.

The cleaning composition also includes (a) a surfactant; and (b) viable Bacillus subtilis in an amount effective to degrade and promote the degradation of organic materials, (c) an aqueous-based gel carrier, with said cleaning composition maintaining the viable Bacillus subtilis such that at least 90% of the organic material is removed from a surface, and the aqueous-based gel carrier has a pH range of 5.0-10.0.

Implementations may include one or more of the following features. The composition where the Bacillus subtilis is present in a concentration of about 1×10⁶/mL to 1×10⁷/mL, 1×10⁷/mL to 1×10⁸/mL, or 1×10⁶/mL to 1×10⁹/mL. The Bacillus subtilis produces proteolytic, amylolytic, lipolytic and/or cellulolytic enzymes as well as mixtures thereof. The organic materials can be any contaminant on a medical instrument. The surfactant is selected from the group of anionic, nonionic, cationic, ampholytic, amphoteric and plant based surfactants. The aqueous-based gel carrier has a pH range of 6-8, 7-8, 5-9 or 4-10. A method for cleaning surgical equipment may include the steps of: (a) treating said equipment with the cleaning composition (b) treating said equipment with said composition for at least 10 minutes, (c) rinsing the composition from said equipment with water, and (d) optionally drying said part to completely remove said rinsing agent from the equipment. The rinsing of the composition results in the removal of at least 90%, 95% or 99% of all organic material. The cleaning composition may include a surfactant selected from the group of anionic, nonionic, cationic, ampholytic, amphoteric and plant based surfactants. The surgical equipment may include a composition of metal, plastic, electronic, or ceramic and combinations thereof

The cleaning composition also includes (a) 0.5-20% by weight viable Bacillus subtilis; (b) 5-20% by weight glycol, (c) 5-20% by weight decyl glucoside, (d) 5-20% by weight lauryl glucoside (e) 5-20% by weight sodium lauroyl lactylate, and the remaining weight comprises water.

Implementations may include one or more of the following features. The cleaning composition where the weight of viable Bacillus subtilis is 0.5-5%, 5-10%, 10-15% or 15-20% of the composition. A method for cleaning surgical equipment may include the steps of: (a) treating said equipment with the cleaning composition (b) treating said equipment with said composition for at least 10 minutes, (c) rinsing the composition from said equipment with water, and (d) optionally drying said part to completely remove said rinsing agent from the equipment. The rinsing of the composition results in the removal of at least 90%, 95% or 99% of all organic material. The cleaning composition may include a surfactant selected from the group of anionic, nonionic, cationic, ampholytic, amphoteric and plant based surfactants.

### DETAILED DESCRIPTION

Reference will now be made in detail to representative embodiments of the disclosure. While the disclosure described is in conjunction with the enumerated embodiments, it will be understood that the disclosure is not intended to be limited to those embodiments. On the contrary, the various embodiments are intended to cover all alternatives, modifications, and equivalents that may be included within the scope of the present disclosure as defined by the claims.

One skilled in the art will recognize many methods and materials similar or equivalent to those described herein, which could be used in and are within the scope of the description. The present disclosure is in no way limited to the methods and materials described.

Unless defined otherwise, technical and scientific terms used herein have the same meaning as commonly understood by one of ordinary skill in the art(s) to which this disclosure belongs. Although any methods, devices, and materials similar or equivalent to those described herein can be used in the practice or testing of the teachings described in this disclosure, the methods, devices and materials are now described.

All publications, published patent documents, and patent applications cited in this disclosure are indicative of the level of skill in the art(s) to which the disclosure pertains. All publications, published patent documents, and patent applications cited herein are hereby incorporated by reference to the same extent as though each individual publication, published patent document, or patent application was specifically and individually indicated as being incorporated by reference.

### DEFINITIONS

As used herein, including the appended claims, the singular forms “a,” “an,” and “the” include plural references, unless the content clearly dictates otherwise, and are used interchangeably with “at least one” and “one or more.” Thus, reference to “an inhibitor” includes mixtures of inhibitors, and the like.

As used herein, the term “about” represents an insignificant modification or variation of the numerical value such that the basic function of the item to which the numerical value relates is unchanged.

The term “each” when used herein to refer to a plurality of items is intended to refer to at least two of the items. It need not require that all of the items forming the plurality satisfy an associated additional limitation.

As used herein, the terms “comprises,” “comprising,” “includes,” “including,” “contains,” “containing,” and any variations thereof, are intended to cover a non-exclusive inclusion, such that a process, method, product-by-process, or composition of matter that comprises, includes, or contains an element or list of elements does not include only those elements but may include other elements not expressly listed or inherent to such process, method, product-by-process, or composition of matter.

As used herein, the term “soil” refers to debris or organic material contaminating medical devices after a procedure.

As used herein, the term “surfactant”, in this disclosure refers to a substance which tends to reduce the surface tension of a solution in which is dissolved. Examples of surfactants include, but are not limited to decyl glucoside, lauryl glucoside and sodium lauroyl lactylate. Incorporation of surfactants or detergents to the gel prevents contaminants from drying out and thereby improving the effectiveness of subsequent cleaning. Gel-based cleaners of surgical devices have the additional benefit of helping to protect the devices from mechanical damage and corrosion that could be incurred during transit between the place of use and the device cleaning area.

As used herein, the term “gel” refers to a liquid or semi-liquid substance containing a dispersion of molecules. The “gel” is characterized as having a viscosity greater than water and adhering to the surface to be cleaned, rather than freely running off the surface.

As used herein, the term “medical device” refers to an instrument, apparatus, implement, machine, contrivance, implant or other similar or related article, including a component part or accessory. The medical device can be a portable device.

The Bacillus subtilis incorporated into the present embodiments produces proteolytic, amylolytic, lipolytic and/or cellulolytic enzymes as well as mixtures thereof. Other types of enzymes may also be produced by the bacteria. Viable Bacillus subtilis refers to naturally occurring microorganism strains classified as BSL-1 by the Center for Disease Control, that are capable of producing a variety of enzymes determined by the type of contaminant to be cleaned. The contaminant can be any organic compound on a medical instrument. The compositions described in the present embodiments include a strain of B. subtilis capable of surviving in the intended environment and having the ability to produce enzymes capable of degrading, or promoting the degradation of, oils, hydrocarbons and other waste materials that may adhere to medical devices. The bacteria is anaerobic and/or aerobic such that it will propagate with and without air in the environment. The compositions of the present embodiments are maintained at a range of pH of 5-10 in order to ensure proper conditions for bacteria to germinate and produce enzymes required to actively degrade organic compounds. In one embodiment, the pH range is 4-10. In one embodiment, the pH range is 5-9. In one embodiment, the pH range is 6-8. In one embodiment the pH range is between 7-8.

An operable range of concentration of viable bacteria is from about 1×10⁶/mL to 1×10⁹/mL. In one embodiment, the range is from about 1×10⁶/mL to 1×10⁷/mL. In one embodiment, the range is from about 1×10⁷/mL to 1×10⁸/mL. In one embodiment the viable bacteria make up 0.5-5% by weight of the composition. In one embodiment the viable bacteria make up 5-10% by weight of the composition. In one embodiment the viable bacteria make up 10-15% by weight of the composition. In one embodiment the viable bacteria make up 15-20% by weight of the composition.

In one embodiment the composition comprises the surfactant. The surfactant comprises anionic, nonionic, cationic, ampholytic and/or amphoteric surfactants and combinations thereof. Such surfactants include, but are not limited to alcohol ethoxylates, glucosides, lactylates, glycols, glycol ethers, and glycerin, and combinations thereof.

The term medical device as used herein is intended to include machined parts and machinery surfaces including materials made of plastic, metal, alloys thereof or combinations thereof and included electronic components and electrical parts. Metallic surfaces include ferrous and non-ferrous surfaces. Ferrous surfaces include, but are not limited to steel, surgical steel, cold rolled steel, cast iron, tin plated steels, copper plated steels, organic coated steels, galvanized steels and zinc/aluminum galvanized steels. Non-ferrous surfaces include, but are not limited to, aluminum and aluminum alloys, zinc and zinc-based alloys, zinc-aluminum alloys and copper and copper alloys.

Plastic surfaces include, but are not limited to, polycarbonates, polyvinyl chlorides, polyethylenes, polypropylenes, thermoplastic polyesters or polyamides, polyurethanes, epoxides or polyepoxides, polystyrene or its copolymers, nylons and modified polyamides, and modified celluloses.

Contacting the surface of the instrument and/or device with the cleaning composition is achieved by any means known in the art. Typical contacting methods include covering, either wholly or partially, the surface of the equipment to be cleaned with the composition. This includes, but is not limited to spraying, immersion, coating, painting, and dipping. Additionally, all forms of immersion cleaning are contemplated by these embodiments. The contact time between the surface to be cleaned and the composition is at least 30 minutes. In one embodiment, the contact time is at least 20 minutes. In one embodiment the contact time is at least 10 minutes. In one embodiment, the contact time is at least 40 minutes. In one embodiment the contact time is at least 60 minutes. In one embodiment, the contact time is between 10 minutes and 60 minutes. In one embodiment, the contact time is between 30 minutes and 2 hours. Removal of the composition from the surface is achieved by any means known in the art, such as thorough rinsing with water.

As will be appreciated by those skilled in the art, the contact time between the gel and the device an/or instrument will vary depending on various factors, such as the type of surface being cleaned, the degree to which the surface is “soiled” and the type of material soiling the surface. Adjustment of contact time to maximize the effects of the methods of the present embodiments are within the scope of one skilled in the art.

### EXAMPLES

The following examples are provided for illustrative purposes only and are not intended to limit the scope of the embodiments as defined by the appended claims. All examples described herein may be carried out using standard techniques, which are well known and routine to those of skill in the art.

### EXAMPLE A

Composition of gel:

| | Weight % |
|---|---|
| Bacillus subtilis | 1-10 |
| Glycol | 5-20 |
| Decyl Glucoside | 5-10 |
| Lauryl Glucoside | 5-10 |
| Sodium Lauroyl Lactylate | 5-10 |
| Water | q.s. to 100 |

### EXAMPLE B

Composition of gel:

| | Weight % |
|---|---|
| Bacillus subtilis | 10.0 |
| Glycol | 15.0 |
| Decyl Glucoside | 5.0 |
| Lauryl Glucoside | 2.5 |
| Sodium Lauroyl Lactylate | 1.5 |
| Water | q.s. to 100 |

### EXAMPLE C

Composition of gel:

| | Weight % |
|---|---|
| Bacillus subtilis | 10.0 |
| Glycol | 20.0 |
| C9-11 Ethoxylated Alcohol | 5.0 |
| Triethanolamine | 2.5 |
| Xanthan Gum | 0.5 |
| Water | q.s. to 100 |

### EXAMPLE D

The composition of Example A is used to remove organic materials from an infusion pump during transport of the pump between the place of use and the equipment cleaning area.

### EXAMPLE E

The composition of Example A is used following use of medical equipment following an operation on a patient. The medical equipment is sprayed with or submerged in the composition at the site of use, following use in the operation or medical procedure. The equipment is then transferred to a cleaning facility. The medical equipment is rinsed at the cleaning facility. The total time from submersion in the composition, to rinse for the medical equipment is at least 30 minutes. Following the rinse, the equipment is 99% free of organic material.

What is claimed is:

1. A cleaning composition comprising:
(a) a surfactant;
(b) viable Bacillus subtilis in an amount effective to degrade and promote the degradation of organic materials; and
(c) an aqueous-based gel carrier;
wherein said cleaning composition maintains the viable Bacillus subtilis such that at least 90% of the organic material is removed from a surface; and the aqueous-based gel carrier has a pH range of 5.0-10.0.

2. The composition of claim 1 wherein the Bacillus subtilis is present in a concentration selected from the group consisting of about 1×10⁶/mL to 1×10⁷/mL, 1×10⁷/mL to 1×10⁸/mL and 1×10⁶/mL to 1×10⁹/mL.

3. The composition of claim 1 wherein the Bacillus subtilis produces proteolytic, amylolytic, lipolytic and/or cellulolytic enzymes as well as mixtures thereof.

4. The composition of claim 1 wherein the organic materials can be any contaminant on a medical instrument.

5. The composition of claim 1 wherein the surfactant is selected from the group of anionic, nonionic, cationic, ampholytic, amphoteric and plant based surfactants.

6. The composition of claim 1 wherein the aqueous-based gel carrier has a pH range selected from the group consisting of 6-8, 7-8, 5-9 and 4-10.

7. A cleaning composition comprising:
(a) 0.5-20% by weight viable Bacillus subtilis;
(b) 5-20% by weight Glycol;
(c) 5-20% by weight Decyl Glucoside;
(d) 5-20% by weight Lauryl Glucoside
(e) 5-20% by weight Sodium Lauroyl Lactylate; and
the balance by weight comprises water.

8. The cleaning composition of claim 7 wherein the weight of viable Bacillus subtilis is selected from the group consisting of 0.5-5%, 5-10%, 10-15% and 15-20% of the composition.

9. A method for cleaning surgical equipment comprising the steps of:
(a) treating said equipment with a cleaning composition;
(b) contacting said equipment with said composition for at least 10 minutes;
(c) rinsing said composition from said equipment with water; and
(d) optionally drying said equipment to completely remove said rinsing agent from said equipment.

10. The method of claim 9, wherein the cleaning composition comprises the composition of claim 1.

11. The method of claim 9 wherein the rinsing of said composition results in the removal of at least 90%, 95% or 99% of all organic material.

12. The method of claim 9, wherein said cleaning composition comprises a surfactant selected from the group of anionic, nonionic, cationic, ampholytic, amphoteric and plant based surfactants.

13. The method of claim 9, wherein the cleaning composition comprises the composition of claim 7.

14. The method of claim 13 wherein the rinsing of the composition results in the removal of at least 90%, 95% or 99% of all organic material.

15. The method of claim 13, wherein the cleaning composition is comprised of a surfactant selected from the group of anionic, nonionic, cationic, ampholytic, amphoteric and plant based surfactants.

16. The method of claim 9 wherein the surgical equipment comprises a composition of metal, plastic, electronic, or ceramic and combinations thereof.
